(19) United States
(12) Patent Application Publication
(10) Pub. No.: US 2005/0050441 A1
(43) Pub. Date: Mar. 3, 2005

(54) Project monitoring method, system, and program product

(76) Inventor: Steven J. Kearney, Schenectady, NY (US)

Correspondence Address: Steven J. Kearney, 110 Fasula Blvd., Schenectady, NY, 12303, US

(21) Appl. No.: 10/891,630

(22) Filed: Jul. 15, 2004

Related U.S. Application Data
(60) Provisional application No. 60/488,025, filed on Jul. 17, 2003.

(51) Int. Cl. G06F 17/00

(52) U.S. Cl. 715/500

(57) ABSTRACT

An asset monitoring system comprising hierarchical information using the most current available data. Data consisting of at least one variable and sometimes known trigger values or values which can be statistically calculated, collected by any electronic means, and made available for further integration with additional information until all required information necessary to predict at least one condition of the asset is collected. The stored information and any additional calculated values will be made available for electronic presentation. The system and corresponding real-time information processing results will aid decision making regarding the most current economic equivalence of the asset, provide actionable alerts by any electronic means for further intervention either electronically automated or requiring manual input from the user of the system, and/or provide predictability charting of the asset based on the stored variables.

### BACKGROUND OF THE INVENTION

1. Technical Field

The invention relates generally to project monitoring, and more particularly to a solution that allows current data on a project to be incorporated into the decision-making process for several aspects of the project.

2. Related Art

In the past, a financial investment in a large physical asset is approved based on assumptions made by underwriters. Investors only require periodic reports from the new owner after closing with no real key metric(s) tracking the original assumptions. The economic status of these types of financial investments and their environments are often clearly understood by only a few insiders. Frequently, the causal relationships of the multitudes of constantly changing factors are too much for these few insiders to manage. This is especially true when combined with growth, or in an economy where knowledgable workers are asked to do more with less.

Recently, the focus for the investors (i.e., banks, owners, and managers of the financed physical assets) has shifted toward providing much more attention to minimizing costs and optimizing the operations of the physical asset. As a result, the investors increasingly desire real-time data retrieval to assist them in making decisions. However, current systems do not filter, process, or integrate the data in a manner that is conducive for such high-level analysis of the physical asset.

As a result, a need exists for a method, system, and program product that integrates current data into reports and the like that are conducive for review by financiers, bankers, and investment firms. Further, a need exists to integrate this solution with the requirements of asset managers, accounting managers, and engineering team support structures.

### BRIEF SUMMARY OF THE INVENTION

A solution for monitoring a project is provided that performs financial asset monitoring over a network for multi-tiered asset management. The invention makes data on the financial asset electronically accessible by prospective managers including project, marketing, finance, engineering, and executive reporting interests. Further, the invention uses data from each entity's databases, computers, networks, information services, control systems, and the Internet to monitor, logically group, identify causal relationships, predict, and perform “what-if” analysis on the asset. The information is made available electronically, secure, derived from its source, and delivered only to a respective party. The information can be delivered in real-time as a monitor, for alerts, and/or upon a request for current economic evaluation. Further, the information can be incorporated into historical data for trending, modeling, and/or marketing. The invention can also provide a flexible framework that can combine applications into a single collaborative portal using real-time data on secure networks that manage, disseminate, filter, deliver, automate, and optimize its transmission.

In one embodiment, the invention includes a framework that allows for the integration of open ended data sources involving a service oriented architecture. This portal application must be flexible enough to add or share collaborative applications, disseminate real-time data feeds and customize reports based on the user's requirements.

In another embodiment, the invention comprises a rich thin client that utilizes the Macromedia Flash player hosted within a web-browser on a desktop PC or Macintosh computer. The flash player natively supports most popular operating-systems and web-browsers available. The flash player and flash development tools provided by Macromedia, Inc. allow software developers to easily create much more intuitive and meaningful applications and experiences that are viewable using a standard web browser or an ever increasing number of PDA type devices. The invention can take advantage of the flash player's flexibility and powerful scripting in combination with the player's ability to connect to and display many disparate types of data and or web-services.

Further, the invention can include one or more servers, that comprise a standard http web-server to distribute simple cross-platform html and flash content. The flash player is connected directly to the Flash Communication Server (FCS) which makes intelligent and intuitive collaboration amongst remote business partners and individuals possible. The FCS provides data to the flash front-end via an optimized “push” method. Instead of every client that views data using the invention requesting the data they'd like to view from the data store, the FCS server caches previously requested data in what is called a “remote shared object.” The remote shared object allows the FCS to provide only the necessary data as it is requested, and furthermore to push new data to the screen as that data changes. This helps reduce network bottlenecks, and optimizes bandwidth usage, thus lowering costs. It also has the added benefit of providing a less stressful environment for the enterprise database servers that are most likely already stressed to their limits by internal everyday use.

The FCS can use a binary data transfer protocol called real time message protocol (RTMP) in order to get the data to the flash player and subsequently the users screen. This protocol is optimized for network transfer, and is natively understood by both parties. The FCS gets it's data via another protocol introduced by Macromedia called the action message format (AMF) protocol. This is also a binary transfer, further optimizing the data flow and keeping bandwidth overhead to a minimum. When understanding these two protocols is a native functionality of all software utilized by the invention, data can be transferred in as close to a real-time format as the network (e.g., the Internet) allows. These protocols and methods are flexible enough to not be out-dated as the network architecture continues to grow and change.

In addition to the FCS, the invention can include a host of data gathering web-services in order to gather data from remote sources. These remote data sources can be practically any database or web-service made available via standard Internet web-service protocols, or through the open database connectivity (ODBC) of most enterprise level database servers. In one embodiment, the invention combines these data services and collects the data on servers in order to share data amongst separate users of the invention. This means that, for instance, weather data can be collected once at a server, but can be viewed by any number of clients, even clients who are in completely unrelated industries, without having to make a new request to the data provider for each connected client. The idea is analogous to a television broadcast, where there is only one broadcast, but any number of televisions can tap into that feed in order to view it, without causing an increased load on the broadcasters hardware and networks.

The invention can also include reporting automation and single sourced data. For example, a facility can generate operational data that a bank project manager may ask the asset manager to compile. The asset manager in turn would recompile this data for executive reporting interests. One embodiment of this invention is to have only one source of this data that can be compiled by any individual in the network (with permissions) for reporting interests. This reduces cycle time to reporting and eliminates the risk of human error in reproducing the data.

Various embodiments of the invention can include one or more beneficial aspects. For example, these aspects can include: implementing information delivery in a platform independent manner so that it can run in multiple operating system and protocol environments; integrating content, communications, and application interfaces into a common experience; providing a services architecture that provides and consumes web services and data services running on application servers; broadcasting and communicating data to multiple clients connected to the application; automatically recognizing project participants that are online; synchronizing instances of the application on multiple project participants' computers; including a desktop application that has shared collaborative applications such as audio, video, instant messaging, spreadsheets, shared images, weather, drawing boards, and project specific proformas; and providing real-time alerts in a graphical user interface (GUI), cell phone, or any portable device.

One embodiment of the invention is further discussed in the accompanying documentation which is hereby incorporated in its entirety. The documentation is for a particular embodiment of the invention that was implemented by Claracy, LLC for a company, named PurEnergy LLC. In this embodiment, the invention was implemented at a site referred to as “Kingsburg,” and includes a web application referred to as “Helios.”

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method of monitoring a project, comprising:
obtaining data from at least one location for the project;
integrating the data with additional data from a recipient; and
formatting the data for review by the recipient, wherein the recipient is selected from the group consisting of: an investor, a manager, an operator, and an engineer.

2. A system for monitoring a project, the system comprising:
a data retrieval system for obtaining data from at least one location for the project;
a metadata system for obtaining data from a recipient;
an integration system for integrating the data; and
a presentation system for presenting the integrated data to the recipient, wherein the recipient is selected from the group consisting of: an investor, a manager, an operator, and an engineer.

3. A computer program product that implements the method steps of claim 1.
